(19) United States
(12) Patent Application Publication
(10) Pub. No.: US 2024/0259856 A1
(43) Pub. Date: Aug. 1, 2024

(54) RADIO ACCESS NETWORK (RAN) ENHANCEMENTS FOR UPLINK PROTOCOL DATA UNIT (PDU) SETS

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US); Prashanth Haridas HANDE, San Diego, CA (US)

(21) Appl. No.: 18/511,900

(22) Filed: Nov. 16, 2023

Related U.S. Application Data
(60) Provisional application No. 63/438,210, filed on Jan. 10, 2023.

(51) Int. Cl. H04W 28/02; H04W 28/06

(52) U.S. Cl. CPC H04W 28/0236; H04W 28/0268; H04W 28/06

(57) ABSTRACT

A method for wireless communication by a first wireless communication device includes receiving, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets. The method also includes adjusting a configuration of a second set of uplink packets in accordance with receiving the latency report. The method further includes transmitting the second set of uplink packets in accordance with adjusting the configuration.

### CROSS-REFERENCE TO RELATED APPLICATION

The present application claims the benefit of U.S. Provisional Patent Application No. 63/438,210, filed on Jan. 10, 2023, and titled “RADIO ACCESS NETWORK (RAN) ENHANCEMENTS FOR UPLINK PROTOCOL DATA UNIT (PDU) SETS,” the disclosure of which is expressly incorporated by reference in its entirety.

### FIELD OF THE DISCLOSURE

The present disclosure relates generally to wireless communication, and more specifically to radio access network (RAN) enhancements for uplink protocol data unit (PDU) sets.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

A protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER). PDU sets may have different decoding criteria (e.g., PDU set content criteria (PSCC)), which may be dependent on an implementation of a given application. A PDU set may be a downlink PDU set or an uplink PDU set.

### SUMMARY

In aspects of the present disclosure, a method for wireless communication includes receiving, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. The method further includes adjusting a configuration of a second set of uplink packets in accordance with receiving the latency report. The method also includes transmitting the second set of uplink packets in accordance with adjusting the configuration.

Other aspects of the present disclosure are directed to an apparatus including means for receiving, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. The apparatus further includes means for adjusting a configuration of a second set of uplink packets in accordance with receiving the latency report. The apparatus also includes means for transmitting the second set of uplink packets in accordance with adjusting the configuration.

In other aspects of the present disclosure, a non-transitory computer-readable medium with non-transitory program code recorded thereon is disclosed. The program code is executed by a processor and includes program code to receive, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. The program code further includes program code to adjust a configuration of a second set of uplink packets in accordance with receiving the latency report. The program code further also includes program code to transmit the second set of uplink packets in accordance with adjusting the configuration.

Other aspects of the present disclosure are directed to an apparatus having one or more processors and one or more memories coupled with the one or more processors and storing instructions operable, when executed by the one or more processors, to cause the apparatus to receive, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. Execution of the instructions further cause the apparatus to adjust a configuration of a second set of uplink packets in accordance with receiving the latency report. Execution of the instructions also cause the apparatus to transmit the second set of uplink packets in accordance with adjusting the configuration.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4A, 4B, 4C, 4D, and 4E are block diagrams illustrating examples of different architectures for processing different protocol data unit (PDU) sets at a UE, in accordance with various aspects of the present disclosure.

FIG. 4F is a block diagram illustrating an example of a conventional architecture for processing different protocol data unit (PDU) sets at a UE.

FIG. 5 is a block diagram illustrating an example of a service data adaptation protocol (SDAP) packet, in accordance with various aspects of the present disclosure.

FIG. 6A is a block diagram illustrating an example an uplink medium access control (MAC) protocol data unit (PDU).

FIG. 6B is a block diagram illustrating an example an uplink medium access control (MAC) transport block (TB), in accordance with various aspects of the present disclosure.

FIG. 7A is a block diagram illustrating an example of a packet data convergence protocol (PDCP) control PDU associated with a latency report, in accordance with various aspects of the present disclosure.

FIG. 7B is a block diagram illustrating an example of a radio link control (RLC) control PDU associated with a latency report, in accordance with various aspects of the present disclosure.

FIG. 7C is a block diagram illustrating an example of a MAC control element (MAC-CE) associated with a latency report, in accordance with various aspects of the present disclosure.

FIG. 8 is a block diagram illustrating an example wireless communication device that supports receiving a latency report associated with one or more PDU sets, in accordance with some aspects of the present disclosure.

FIG. 9 is a flow diagram illustrating an example process performed by a wireless communication device, in accordance with some aspects of the present disclosure.

### DETAILED DESCRIPTION

Various aspects of the disclosure are described more fully below with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

A protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER).

Still, in some examples, one or more QoS attributes may be different between PDU sets. In some such examples, PDU sets may have different decoding criteria (e.g., PDU set content criteria (PSCC)), which may be dependent on an implementation of a given application. Within a service data flow, there may be different types of data, such as video frame data or audio data. The different decoding criteria may be specified for the different types of data. For example, some PDU sets may be associated with an all or nothing decoding criteria, in which the PDU set may be obsolete if a receiver fails to decode a PDU in the PDU set. As another example, some other PDU sets may be associated with a good until a first loss decoding criteria, in which all received PDUs are valid until the first loss occurs. In yet another example, some other PDU sets may be associated with an application-layer forward error correction (AL-FEC) decoding criteria, in which PDUs in a PDU set are encoded using AL-FEC. In some cases, based on a redundancy ratio of the FEC, only a subset of PDUs in the PDU set may be used to decode the PDU set.

In some examples, one or more PDUs in a PDU set may be discarded by a user equipment (UE) or a radio access network (RAN). In some such examples, the one or more PDUs may be discarded when a delay budget has been exhausted. Alternatively, the one or more PDUs may be discarded if an associated layer-2 timer has expired. The layer-2 timer may be a packet data convergence protocol (PDCP) discard timer, a radio link control (RLC) reassembly timer, an RLC discard timer, or a PDCP reordering timer. In some other examples, a PDU may be discarded based on the decoding criteria (e.g., content criteria) associated with the PDU set being satisfied or if the decoding criteria can no longer be satisfied. In some such examples, the decoding criteria may no longer be satisfied if the receiver failed to decode a PDU in the PDU set and the decoding criteria is: all or nothing, or good until the first loss. In other such examples, the decoding criteria may have been satisfied if one or more PDUs in the PDU set have been successfully decoded, such that additional PDUs in the PDU set are no longer necessary.

As discussed, a PDU set may be a downlink PDU set or an uplink PDU set. Both the uplink PDU sets and the downlink PDU sets may include PDU sets with different QoS attributes. Various aspects of the present disclosure are directed to providing an architecture, at a UE, that supports PDU sets with different QoS attributes. In some examples, one or more data radio bearers (DRBs) may be established between the UE and a network node. Additionally, one or more quality of service (QoS) flows may be mapped to each DRB of the one or more DRBs. Each of the one of more QoS flows is associated with one PDU set type of a group of PDU set types or a sub-group of PDU set types of a group of PDU set types. The UE may transmit one or more PDUs associated with one or more PDU sets. Each PDU set may be associated with a sub-QoS flow or a QoS flow.

Various aspects of the present disclosure are directed to indicating a latency and a number of lost packets for a group of packet transmissions, where each packet in the group of packets is associated with a PDU set. In some examples, a wireless device, such as a network node, may receive a latency report indicating a first latency value associated with an initial uplink packet of a first set of uplink packets associated with a given medium access control (MAC) transport block (TB), a second latency value associated with a final uplink packet of the first set of uplink packets, and a number of uplink packets lost in the first set of uplink packets. For example, a network node may grant an uplink (UL) MAC TB. In response, the UE may send packets in MAC TB. The UE may indicate a delay associated with a first packet and/or a delay associated with a last packet. These packets may be for the absolute first and last packet in the MAC TB or these packets may be the first and last packet of a specific flow in the MAC TB. Additionally, the number of lost uplink packets may be across the bearer or specific to a flow configured by the network node. The network node may adjust a configuration of a second set of uplink packets in accordance with receiving the latency report. The network node may also transmit the second set of uplink packets in accordance with adjusting the configuration.

Particular aspects of the subject matter described in this disclosure can be implemented to realize one or more of the following potential advantages. In some examples, the described techniques, such as indicating a latency associated with an initial PDCP packet, a latency associated with a final PDCP packet, and a number of lost packets may enable a network node to re-configure one or more of a grant size, a grant periodicity, or a grant timing to reduce latency, packet discard losses, and/or transmission errors.

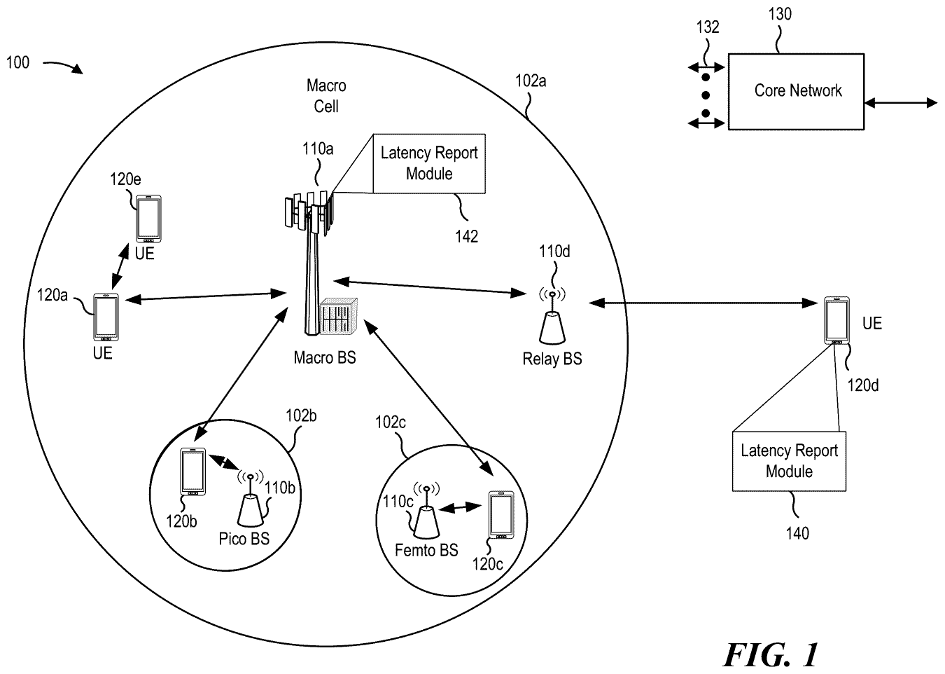

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” maybe used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

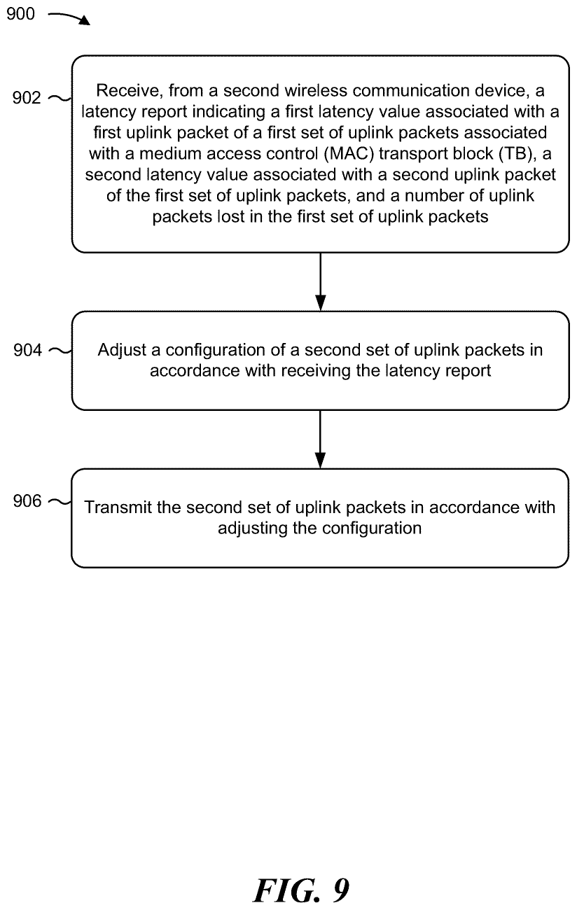

The UEs 120 may include a latency report module 140. For brevity, only one UE 120d is shown as including the latency report module 140. Additionally, or alternatively, the base station 110 may include a latency report module 142. The latency report modules 140 and 142 may implement one or more steps of the process 900 described with reference to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

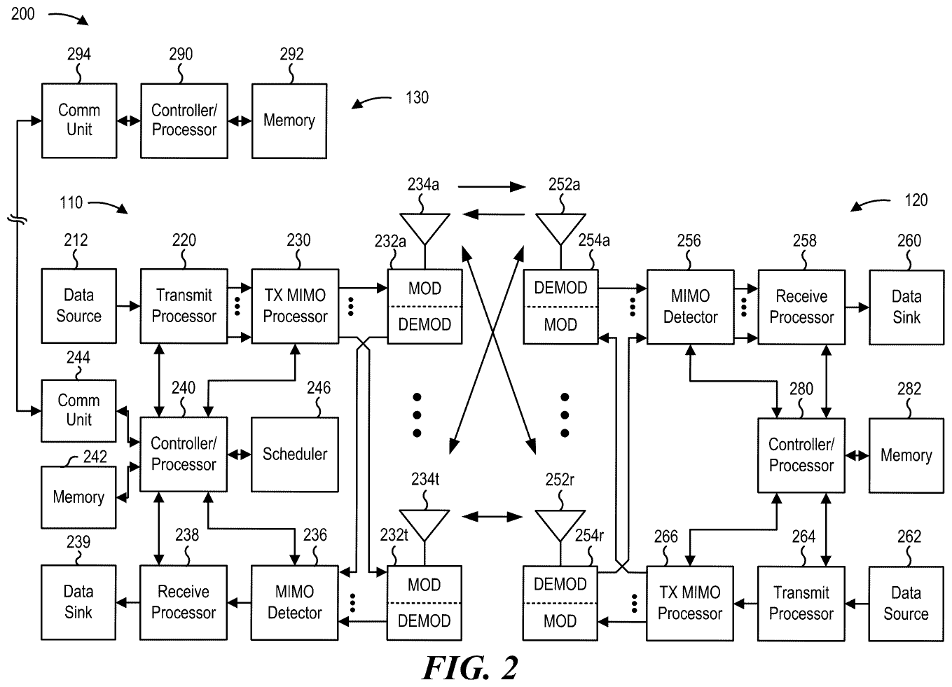

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with supporting PDU sets as described in more detail elsewhere. For example, the controller/processor 240 of the base station 110, the controller/processor 280 of the UE 120, and/or any other component(s) of FIG. 2 may perform or direct operations of, for example, the process of FIG. 9 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

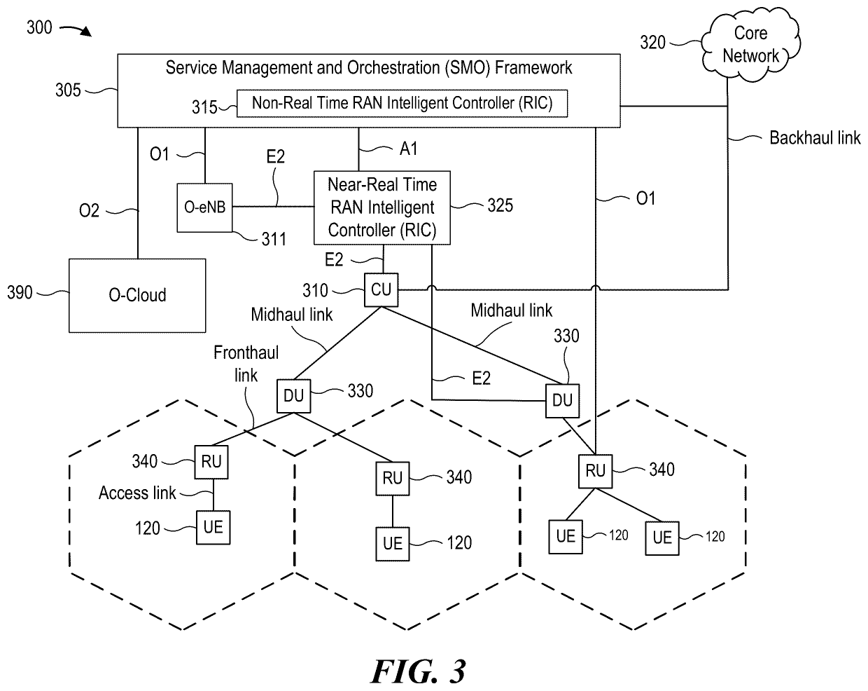

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

A communications protocol stack may be implemented by devices operating in a wireless communication system, such as a 5G system, a 6G system, or another type of wireless communication system. The communications protocol stack includes a radio resource control (RRC) layer, a packet data convergence protocol (PDCP) layer, a radio link control (RLC) layer, a medium access control (MAC) layer, and a physical (PHY) layer. In various examples, the layers of a protocol stack may be implemented as separate modules of software, portions of a processor or ASIC, portions of non-collocated devices connected by a communications link, or various combinations thereof.

As discussed, a protocol data unit (PDU) set may be specified for a wireless service, such as an extended reality (XR) service. A PDU set is a set of PDUs that may be delivered as an integrated unit to a receiver. For example, a PDU set may be associated with a video frame or a slice within a video frame. In some examples, all PDUs in a same PDU set share common quality of service (QoS) attributes, such as, for example, a PDU set delay budget (PSDB) or a PDU set error rate (PSER).

In some examples, PDU sets may have different decoding criteria (e.g., PDU set content criteria (PSCC)), which may be dependent on an implementation of a given application. For example, some PDU sets may be associated with an “all or nothing” decoding criteria, in which the PDU set may be obsolete if a receiver fails to decode a PDU in the PDU set. As another example, some other PDU sets may be associated with a “good until a first loss” decoding criteria, in which all received PDUs are valid until the first loss occurs. In yet another example, some other PDU sets may be associated with an application-layer forward error correction (AL-FEC) decoding criteria, in which PDUs in a PDU set are encoded using AL-FEC. In some cases, based on a redundancy ratio of the FEC, only a subset of PDUs in the PDU set may be used to decode the PDU set.

In some examples, one or more PDUs may be discarded by a user equipment (UE) or a radio access network (RAN). In some such examples, a PDU may be discarded when a delay budget has been exhausted. Alternatively, the PDU may be discarded if an associated layer-2 timer has expired. The layer-2 timer may be a PDCP discard timer, an RLC reassembly timer, an RLC discard timer, or a PDCP reordering timer. In some other examples, a PDU may be discarded based on the decoding criteria (e.g., content criteria) associated with the PDU set being satisfied or if the decoding criteria can no longer be satisfied. In some such examples, the decoding criteria may no longer be satisfied if the receiver failed to decode a PDU in the PDU set and the decoding criteria is: all or nothing, or good until the first loss. In other such examples, the decoding criteria may have been satisfied if one or more PDUs in the PDU set have been successfully decoded, such that additional PDUs in the PDU set are no longer necessary.

In some examples, a PDU set may be a downlink PDU set or an uplink PDU set. Various aspects of the present disclosure are directed to supporting one or more uplink PDU sets at a UE. Uplink PDU sets may share one or more features with downlink PDU sets. In some examples, a packet filter used for downlink PDU set marking may be used for uplink packet filtering. For example, the uplink packet filtering may match a real-time transport protocol (RTP) or a secure RTP (SRTP) header and payload. Additionally, each uplink PDU set may be associated with one or more QoS attributes, such as one or both of a PSDB or a PSER. The PSDB may be an upper bound for a delay between a time when a last PDU in an uplink PDU set is received at an SDAP service access point of a UE and a time when the uplink PDU set is successfully received at a receiver (e.g., network node). The PSER may be an upper bound for a ratio between a number of uplink PDU sets that were not successfully decoded (e.g., received) and a total number of uplink PDU sets sent within a measurement window.

In some examples, the uplink PDU set may include one or more information elements. The one or more information elements may include a PDU set identifier (e.g., sequence number), a boundary indication of an uplink PDU set (e.g., a start and an end of a PDU set), or traffic parameters (e.g., periodicity). Additionally, the one or more information elements may include one or more optional elements, such as a PDU set size represented as bytes or a number of PDUs in the PDU set, an importance of the PDU set, or whether in-order delivery of the PDUs in the PDU set is specified.

In some examples, a PDU set importance is associated with each PDU set instead of a QoS flow. That is, each PDU set may be assigned its own importance level. However, regardless of an importance level, each PDU set with the same QoS flow ID (QFI) may be associated with a same QoS flow. Additionally, in some examples, a PSDB and a PSER may be configured for a QoS flow. The PSDB may be common to all PDU sets associated with a QoS flow. In contrast, the PSER may be measured based on a set of PDU sets transmitted within a time window. Therefore, if a UE selectively discards PDU sets, then PDU sets with a high importance may have a lower PSER than other PDU sets, while the overall error rate still satisfies the PSER. Thus, an importance of a PDU set may be orthogonal to a PSDB associated with the PDU set. Additionally, the importance of the PDU set may be related to a differentiated reliability of decoding the PDU set (e.g., error/loss rate). In some examples, PDU sets associated with a high importance may be more protected than other PDU sets. For example, high importance PDU sets may be selectively duplicated. Additionally, or alternatively, scheduling may be prioritized for high importance PDU sets during uplink congestion to reduce a likelihood that a PDU in a high importance PDU set is discarded due to a delay that is greater than a PSDB.

Various aspects of the present disclosure discuss a sub-QoS flow and a QoS flow. The sub-QoS flow may be associated with PDUs having a same importance level or PDUs associated with a same PDU set type. A QoS flow may be a conventional QoS flow. Each QoS flow may be associated with a group of sub-QoS flows.

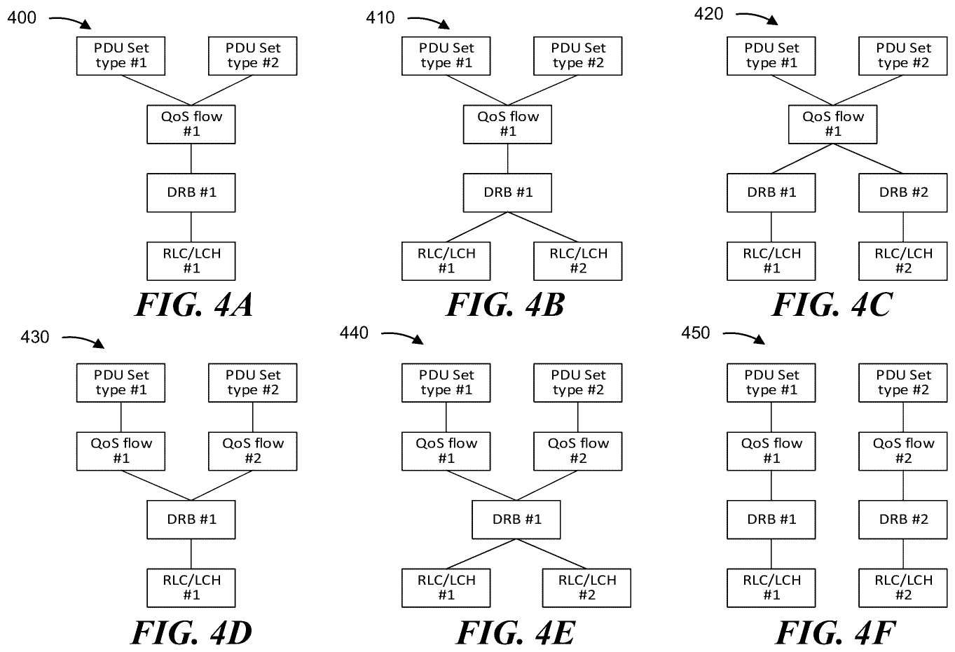

FIG. 4A illustrates an example 400 of an architecture for processing PDU sets at a UE 120, in accordance with various aspects of the present disclosure. In the example 400 of FIG. 4A, two PDU set types (PDU set type 1 and PDU set type 2) may be associated with a same QoS flow (QoS flow 1). Aspects of the present disclosure are not limited to two PDU set types. Additional PDU set types may be associated with the QoS flow. The QoS flow may be mapped to one data radio bearer (DRB) (DRB 1) and the DRB may be associated with a radio link control (RLC) entity (RLC 1). Additionally, the RLC entity may be associated with one logical channel (LCH) (LCH 1). The RLC entity may also be referred to as an RLC layer.

FIG. 4B illustrates an example 410 of an architecture for processing PDU sets at a UE 120, in accordance with various aspects of the present disclosure. In the example 410 of FIG. 4B, two PDU set types (PDU set type 1 and PDU set type 2) may be associated with a same QoS flow (QoS flow 1). The QoS flow may be mapped to one DRB (DRB 1) and the DRB may be associated with two radio link control (RLC) entities (RLC 1 and RLC 2). Additionally, each RLC entity may be associated with an LCH (LCH 1 and LCH 2). Aspects of the present disclosure are not limited to two RLC entities. Additional RLC entities may be associated with the DRB.

FIG. 4C illustrates an example 420 of an architecture for processing PDU sets at a UE 120, in accordance with various aspects of the present disclosure. In the example 420 of FIG. 4C, two PDU set types (PDU set type 1 and PDU set type 2) may be associated with a same QoS flow (QoS flow 1). The QoS flow may be mapped to two different DRBs (DRB 1 and DRB 2). Aspects of the present disclosure are not limited to two DRBs. Additional DRB entities may be associated with the QoS flow. Each DRB may be associated with a different radio link control (RLC) entity (RLC 1 and RLC 2). Additionally, each RLC entity may be associated with an LCH (LCH 1 and LCH 2).

FIG. 4D illustrates an example 430 of an architecture for processing PDU sets at a UE 120, in accordance with various aspects of the present disclosure. In the example 430 of FIG. 4D, each PDU set type (PDU set type 1 and PDU set type 2) may be associated with a different QoS flow (QoS flow 1 and QoS flow 2). The QoS flows may be mapped to the same DRB (DRB 1). The DRB may be associated with a single radio link control (RLC) entity (RLC 1). Additionally, the RLC entity may be associated with an LCH (LCH 1).

FIG. 4E illustrates an example 440 of an architecture for processing PDU sets at a UE 120, in accordance with various aspects of the present disclosure. In the example 440 of FIG. 4E, each PDU set type (PDU set type 1 and PDU set type 2) may be associated with a different QoS flow (QoS flow 1 and QoS flow 2). The QoS flows may be mapped to the same DRB (DRB 1). The DRB may be associated with two radio link control (RLC) entities (RLC 1 and RLC 2). Additionally, each RLC entity may be associated with an LCH (LCH 1 and LCH 2).

FIG. 4F illustrates an example 450 of a conventional architecture for processing PDU sets at a UE 120. In the example 450 of FIG. 4F, each PDU set type (PDU set type 1 and PDU set type 2) may be associated with a different QoS flow (QoS flow 1 and QoS flow 2). The QoS flows may be mapped to the different DRBs (DRB 1 and DRB 2). Each DRB may be associated with a different radio link control (RLC) entity (RLC 1 and RLC 2). Additionally, each RLC entity may be associated with an LCH (LCH 1 and LCH 2).

FIGS. 4A, 4B, 4C, 4D, and 4E illustrate examples of different architectures for processing different PDU sets at a UE, in accordance with various aspects of the present disclosure. If multiple PDU set types are multiplexed into a common QoS flow, then the multiple PDU set types may share the same QoS attributes, such as the same PSDB, PSER, prioritized bit rate (PBR), bucket size duration (BSD), and maximum data burst volume (MDBV). If multiple types of PDU set types are multiplexed into different QoS flows (see FIGS. 4D and 4E), then each QoS flow may be associated with its own QoS attributes, even if each PDU set type is associated with the same traffic flow.

Different enhancements may be specified for the different architectures. For example, the architecture examples 400 and 410 described with reference to FIGS. 4A and 4B may use a PDU set type field in an SDAP header associated with a PDU. In some examples, when a PDU arrives at an SDAP service access point (SAP), a UE may identify a sub-QoS flow or QoS flow associated with the PDU based on the SDAP header.

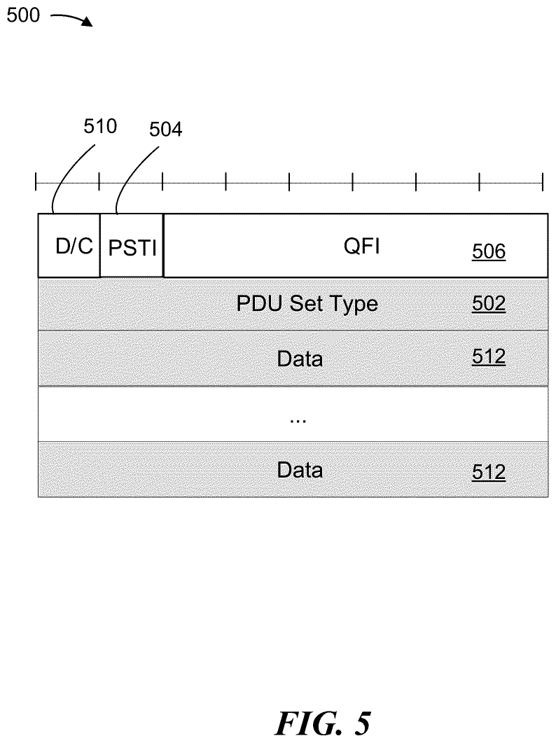

FIG. 5 is a block diagram illustrating an example of a service data adaptation protocol (SDAP) packet 500, in accordance with various aspects of the present disclosure. As shown in the example of FIG. 5, the SDAP packet 500 may include a PDU set type field 502 that indicates a PDU set type associated with the PDU. In some examples, if a PDU set type is included with a data packet, the UE may include the PDU set type in the PDU set type field 502 of the SDAP packet 500 associated with the PDU. Additionally, or alternatively, a PDU set type indicator (PSTI) field 504 may be included in the header to indicate the presence of a value indicating a PDU set type in the PDU set type field 502. Alternatively, if the data packet does not include the PDU set type, the UE may include a QoS flow ID (QFI) in a QFI field 506 of the SDAP packet 500. The SDAP packet 500 may also include a data/control (D/C) bit 510. The D/C bit 510 may indicate whether the PDU is a data PDU or a control PDU. The SDAP packet 500 may also include one or more data fields 512.

As shown in the examples 400 and 430 described with reference to FIGS. 4A and 4D, respectively, a DRB may be served by a common RLC entity and a common LCH. In the example 400 described with reference to FIG. 4A, different sub-QoS flows may be served by the common RLC entity and the common LCH. In the example 430 described with reference to FIG. 4D, different QoS flows may be served by the common RLC entity and the common LCH. Although different sub-QoS flows or different QoS flows may be served by the common RLC entity and the common LCH, PDUs may be processed differently based one or more parameters associated with a respective PDU type (e.g., PDU set). In the examples 400 and 430 described with reference to FIGS. 4A and 4D, each PDU may be associated with a PDU type. The UE may identity the PDU type based on a PDU set type or a QFI included in an SDAP header of a PDU.

There may be multiple possible configurations between a PDU Set, a QoS flow, a DRB entity, and a logical channel. When a UE receives, from a network node, a grant for uplink traffic, the UE may prepare one or more PDUs that belong to different PDU sets as part of a MAC transport block based on logical channel prioritization (LCP) and/or other rules associated with a given logical channel.

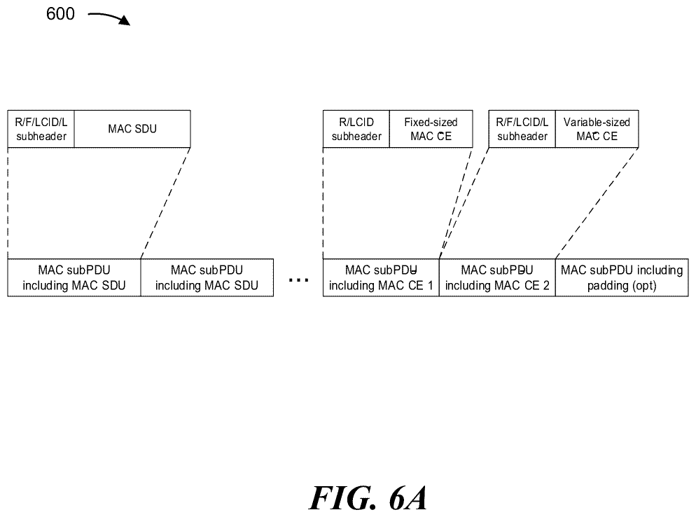

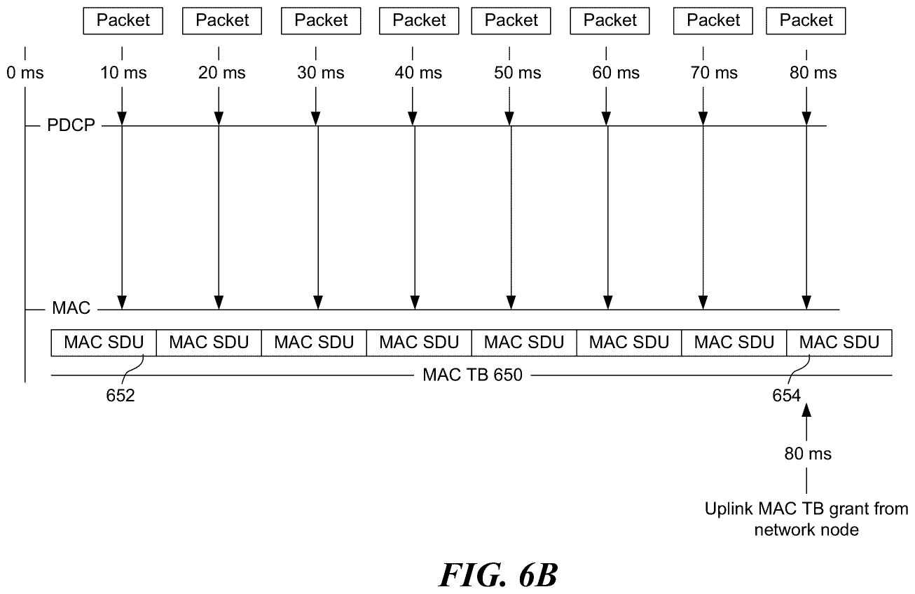

FIG. 6A is a block diagram illustrating an example of an uplink (UL) MAC PDU 600. The UL MAC PDU may include one or more MAC subPDUs. Each MAC subPDU includes one of: a MAC subheader only (including padding); a MAC subheader and a MAC service data unit (SDU); a MAC subheader and a MAC-CE; or a MAC subheader and padding. The MAC SDUs may be of variable sizes. Each MAC subheader corresponds to either a MAC SDU, a MAC-CE, or padding.

In some examples, one or more conditions, such as a latency condition or a block error rate (BLER) condition, associated with a PDU set may not be satisfied. In such examples, an application level may be aware that the one or more conditions were not satisfied. However, in such examples, a network node (e.g., radio access network (RAN)) may be unaware that the one or more conditions were not satisfied. Specifically, knowledge of a PDU set may be limited to applications, such that a radio network controller (RNC), MAC, L1, network node, and/or UE may only know a PDCP sequence number, an RNC sequence number, and/or other information associated with a PDU set. As such, a radio entity (e.g., the network node or the UE) may not have information indicating a start of a video frame and an end of the video frame. Therefore, during an uplink transmission, it may not be evident to a radio entity whether a PDU is lost at the UE uplink waiting for transmission at a PDCP level. For example, the radio entity may be unaware of SDUs, which are not yet built as PDCP PDUs, that are discarded based on a timer discard. The discarded SDUs may only be known at an application level. In one example, a modem at the UE may receive 1000 packets from an application layer and 100 packets may be discarded based on the timer discard. The UE may then transmit 900 packets in response to receiving an uplink grant. However, the loss of the 100 packets may only be known at the application level because from a radio perspective, a sequence number (SN) space may be zero to 899, and the network node may determine that the 900 packets were received without error. It may be desirable to know whether some packets were lost and/or a delay associated with one or more packets to satisfy a QoS flow. In some examples, each PDU set may be associated with a video frame. In such examples, satisfying a QoS flow may enable a video, or other multimedia, to properly (e.g., smoothly) display.

Additionally, or alternatively, in some examples, PDUs may experience latency between a time of arrival at a UE or a transmitting node and an over-the-air (OTA) transmission. For example, in a given MAC transport block (TB), the network node may receive a sequence of ten PDCP PDUs, where four PDCP PDUs are associated with a first PDU set and another four PDCP PDUs are associated with a second PDU set. In this example, at a RAN level, the network node may be unaware of a latency (e.g., delay) associated with an initial packet (e.g., first PDCP PDU) in the MAC TB or a latency associated with a final packet (e.g., last PDCP PDU) in the MAC TB. Each QoS Flow may be associated with latency conditions for each PDU set. However, the RAN may only use the latency conditions (e.g., latency requirements) for downlink scheduling. The RAN at the network node may not use the latency conditions for uplink scheduling. The latency associated with an initial PDCP PDU may be referred to as a first sequence number (SN) latency, and the latency associated with a final PDCP PDU may be referred to as a last SN latency.

FIG. 6B is a block diagram illustrating an example of a MAC TB 650. The MAC TB 650 is associated with a transmission of eight packets every 80 milliseconds (ms). In the example of FIG. 6B, every ten ms, a PDU is received at a PDCP layer of a transmitter (e.g., UE). In this example, four PDCP PDUs are associated with a first PDU set and another four PDCP PDUs are associated with a second PDU set. For ease of explanation, the SDAP and RLC layers are not shown in the example of FIG. 6B. Additionally, MAC headers are omitted from the examples of FIG. 6B. As shown in the example of FIG. 6B, a grant may be received at the 80 ms. The MAC TB 650 may be transmitted to the network node in response to receiving the grant. In this example, a first SN latency associated with a first MAC SDU 652 may be 80 ms and a last SN latency associated with a last MAC SDU 654 may be 0 ms, and some PDUs may be lost due to timer discard. In this example, the average latency is 40 ms. However, the network node is not aware of the first SN latency and the last SN latency. Had the network node been aware of the first SN latency and the last SN latency, the network node may have adjusted an uplink grant to reduce the average latency. For example, rather than granting all eight PDCP PDUs, the network may have granted two packets every 20 ms, such that the first packet would have a ten ms latency and a second packet would have no latency, such that the average latency would be ten ms. As another example, the network node may adjust a periodicity of the grant, such that the grant is transmitted once every 40 ms, rather than once every 80 ms. In this example, the average latency may be reduced to 20 ms.

As another example, a MAC TB transmits eight packets, four PDCP PDUs are associated with a first PDU set and another four PDCP PDUs are associated with a second PDU set. In this example, eight packets associated with the first and second PDU sets arrive, at once, at a PDCP layer of a transmitter (e.g., UE). In this example, the grant may arrive every 40 ms, such that an initial PDU experiences 40 ms latency, a final PDU experiences 40 ms latency, and no packets are lost due to timer discard. In this example, the average latency is 40 ms. Similar to the previous example, the network node is not aware of the first SN latency and the last SN latency. Had the network node been aware of the first SN latency and the last SN latency, the network node may have adjusted an uplink grant to reduce the average latency. As an example, the network node may adjust an offset of the latency by adjusting a timing of the grant. For example, the network node may transmit the grant 30 ms earlier to reduce the average latency to ten ms.

Various aspects of the present disclosure are directed to transmitting a latency report that includes a first SN latency, a last SN latency, and a number of PDCP SDUs lost. The first SN latency, the last SN latency, and the number of PDCP SDUs lost may improve a scheduling mechanism at the network node. In some examples, the latency report may be transmitted via a control packet, such as a PDCP control PDU, RLC control PDU, or MAC-CE. In some implementations, the network node receives the latency report and adjusts one or more of a grant size, a periodicity of a MAC TB, or a timing of a grant. For example, adjusting the grant size may adjust a size of the MAC TB to accommodate more PDUs to reduce a number of lost packets and/or reduce an average latency. As another example, adjusting the periodicity of the grant size may reduce a size of the MAC TB while providing a same effective OTA data rate and reducing an average latency. As previously discussed, in one example, a grant may be transmitted once every 40 ms, rather than once every 80 ms. As another example, adjusting the timing of the grant may reduce an average latency. For example, a grant may be transmitted at times t+30 ms, t+70 ms, and t+110 ms, whereas data may be received at the PDCP layer at times t, t+40 ms, and t+80 ms, thereby causing a 30 ms average latency. In this example, the latency may be reduced if the timing of the grants is reduced by 20 ms, such that the grants are received at t+10 ms, t+50 ms, and t+90 ms. In such an example, the average latency may be reduced from 30 ms to 10 ms.

In some examples, a periodicity of the latency report (e.g., PDCP latency report) may be configured via an RRC message, a QoS configuration, or other control signaling. The periodically transmitted latency report may be associated with a period of time, such as a prior time period (e.g., a prior 100 ms), or a time period since a transmission of a previous latency report. The period of time may be configured by the network node. In such examples, the latency report may include an average first SN latency associated with the time period, an average last SN latency associated with the time period, and a packet loss associated with the time period. The latency report may be periodically transmitted via a control packet a PDCP layer (e.g., PDCP control PDU), a MAC layer (e.g., MAC-CE), an RLC layer (e.g., RLC control PDU), or another mechanism, such as an SDAP control PDU or an RRC message. A measurement report, latency report, or UE assistance information (UAI) are examples of RRC message.

In some other examples, the latency report may be transmitted on demand in response to a request. The request for the on demand latency report may be received via a PDCP, RLC, or MAC mechanism. The on demand latency report may include a current packet loss, first SN latency, and last SN latency in a given MAC TB.

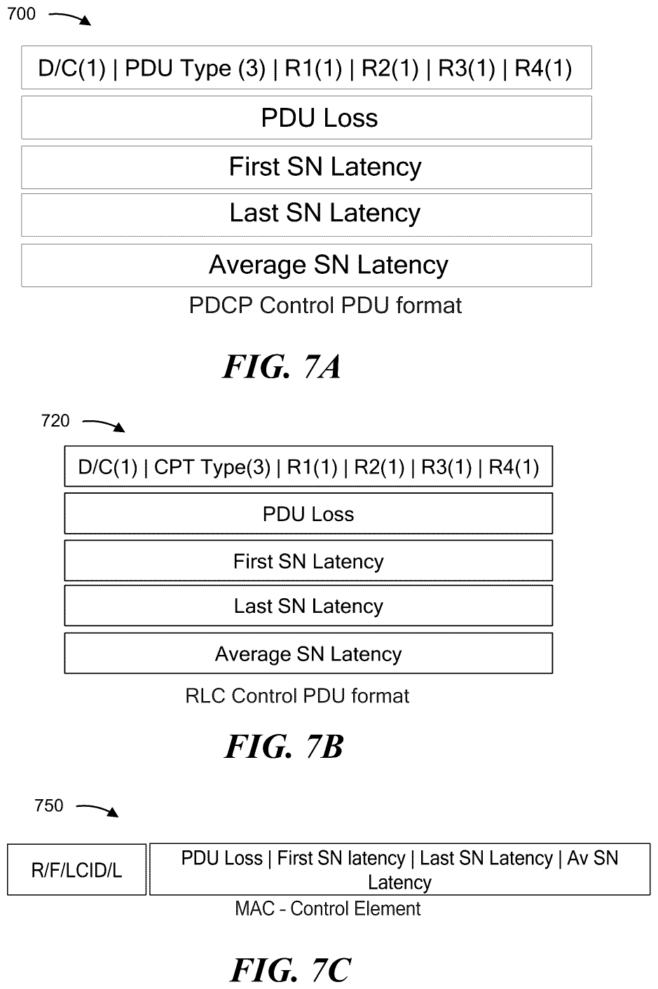

FIG. 7A is a block diagram illustrating an example of a PDCP control PDU 700 associated with a latency report, in accordance with various aspects of the present disclosure. As discussed, aspects of the present disclosure are not limited to transmitting the latency report via a PDCP control PDU 700, other types of messages, such as an RLC control PDU or a MAC-CE, may be used for transmitting the latency report. In the example of FIG. 7A, a header may include a D/C bit, one or more PDU type field bits indicating PDU characteristics, such as periodic or on-demand, an R1 bit indicating a presence of a PDU loss, an R2 bit indicating a presence of a first SN latency, an R3 bit indicating a presence of a last SN latency, and an R4 bit indicating a presence of an average latency. The PDCP control PDU 700 may also indicate the PDU loss, a first SN latency, a last SN latency, and an average SN latency. One or more additional bits may be defined in the PDCP control PDU 700 to indicate other parameters, such as PDU set specific parameters.

FIG. 7B is a block diagram illustrating an example of an RLC control PDU 720 associated with a latency report, in accordance with various aspects of the present disclosure. In the example of FIG. 7B, a header may include a D/C bit, one or more control PDU type (CPT) field bits indicating the type of RLC control PDU, an R1 bit indicating a presence of a PDU loss, an R2 bit indicating a presence of a first SN latency, an R3 bit indicating a presence of a last SN latency, and an R4 bit indicating a presence of an average latency. The PDCP control PDU 700 may also indicate the PDU loss, a first SN latency, a last SN latency, and an average SN latency. One or more additional bits may be defined in the RLC control PDU 720 to indicate other parameters.

FIG. 7C is a block diagram illustrating an example of MAC-CE 750 associated with a latency report, in accordance with various aspects of the present disclosure. In the example of FIG. 7C, the MAC-CE may indicate the PDU loss, a first SN latency, a last SN latency, and an average SN latency. One or more additional bits may be defined in the RLC control PDU 720 to indicate other parameters. Additionally, the sub-header may include one or bits associated with a logical channel identifier (LCID), a length (L), a format (F), or reserved (R).

In addition to, or alternate from, indicating packet loss, the latency report may indicate various values associated with the first SN latency and the last SN latency. In some examples, the latency report may indicate the first SN latency of the first PDU and the last SN latency of the last PDUs within a MAC TB, irrespective of an associated radio bearer or logical channel. In some other examples, the latency report may indicate the first SN latency of the first PDU and the last SN latency of the last PDUs within a MAC TB for a given FLOW. In some other examples, the latency report may indicate the first SN latency of the first PDU and the last SN latency of the last PDUs within a MAC TB for a given PDU set priority or a PDU set type. In some other examples, the latency report may indicate the average first SN latency of the first PDU and the average last SN latency of the last PDUs within a MAC TB. The average first SN latency and the average last SN latency may be from a time of a previous report. In some other examples, the latency report may indicate the first SN latency of the first PDU and the last SN latency of the last PDUs within a MAC TB, in which the first SN latency and the last SN latency are averaged over a specific time period.

In some examples, a flow specific latency report may be configured for a given QoS flow or at a bearer level for all the QoS flows associated with a network node. In some examples, a QoS flow ID (QFI) in the latency report (e.g., PDCP control PDU) indicates that the latency report is a QFI specific report. As an example, the QFI may be included in a header of the PDCP control PDU. In such examples, a UE may include the QFI to cause the network node or the UE to re-configure a specific QFI to a different radio bearer or a different logical channel within one DRB via an RRC procedure, a reflective QoS (RQoS) procedure, or another signaling mechanism.

In some examples, the network node may configure the latency report for a specific radio bearer, a specific logical channel, a specific flow, or a specific PDU set type. In some other examples, the network node may configure the latency report for a specific leg in a dual connection to understand the latencies across master cell group and/or a secondary cell group. Additionally, or alternatively, the latency report for the specific leg may be used to change a mapping configuration from a radio bearer to a carrier group, or to enable/disable PDCP Duplication across RLC legs.

In some examples, a network node may use the latency report to adjust radio resource management (RRM) aspects in terms of grant management, periodicity, switching from a configured grant to a dynamic grant, or switching from the dynamic grant to the configured grant. Additionally, or alternatively, in accordance with receiving the latency report, the network node may adjust one or more logical channel (LC) properties at the RRM, in terms of grant management, for example, the network node may adjust a periodicity of a grant, switching between a configured grant (CG) and a dynamic grant (DG) or vice versa, and/or change a LC configuration, such as a logical channel priority (LCP), packet size, and/or other properties at a MAC and PHY level. Additionally, or alternatively, based on the latency report, the network node may adjust one or more network configurations, MAC layer configurations, or PHY layer configurations.

In some examples, in accordance with receiving the latency report, the network node may dynamically enable/disable various component carriers to satisfy QoS criteria. In some other examples, in accordance with receiving the latency report, the network node may use the latency report to remap a flow to radio bearer mapping using non-access stratum or access stratum resource quality objectives (RQOS) mechanisms in addition to RRC level reconfiguration based mapping procedures. In some examples, in accordance with receiving the latency report, the network node may use the latency report to adapt RAN resources for on-demand PDU Session or update UE route selection policy (URSP) rules for a slice to improve a user experience in terms of a PSDB and/or a PSER. Additionally, or alternatively, in accordance with receiving the latency report, the network node may indicate the QoS characteristics to the session management function (SMF), such that the SMF may review and/or re-configure one or more QoS characteristics. For example, the SMF may adjust codec rates. That is, the latency report may be used for RAN assisted codec adaptation. In some examples, in accordance with receiving the latency report, the network node may update the URSP rules for a given slice to satisfy QoS requirements. In some other examples, in accordance with receiving the latency report, the network node may move altogether to a different slice to satisfy QoS requirements. In some other examples, in accordance with receiving the latency report, the network node may change.

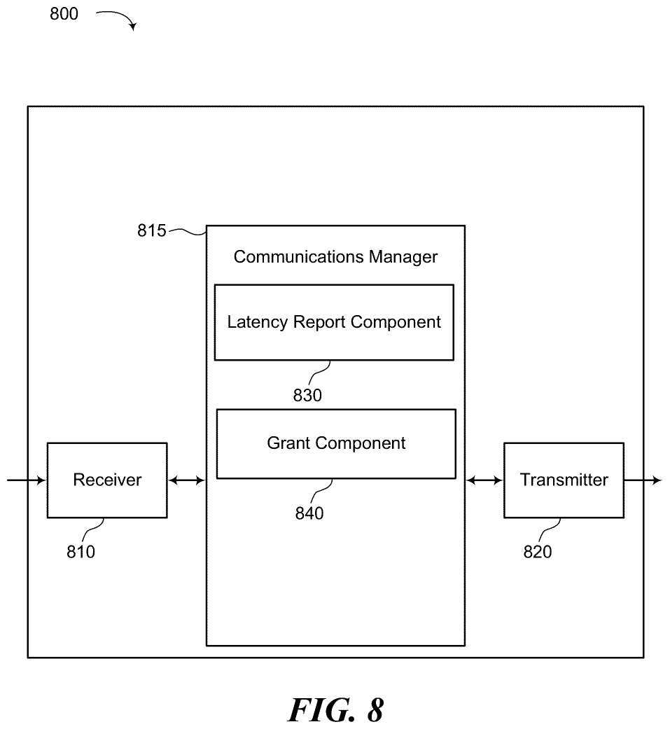

FIG. 8 is a block diagram illustrating an example wireless communication device 800 that supports receiving a group of PDUs associated with one or more PDU sets. The wireless communication device 800 may be an example of a base station 110 as described with reference to FIGS. 1 and 2, a CU 310, DU 330, or RU 340 as described with reference to FIG. 3. The wireless communication device 800 may include a receiver 810, a communications manager 815, a latency report component 830, a grant component 840, and a transmitter 820, which may be in communication with one another (for example, via one or more buses). In some examples, the wireless communication device 800 is configured to perform operations, including operations of the process 900 described below with reference to FIG. 9.

In some examples, the wireless communication device 800 can include a chip, system on chip (SOC), chipset, package, or device that includes at least one processor and at least one modem (for example, a 5G modem or other cellular modem). In some examples, the communications manager 815, or its sub-components, may be separate and distinct components. In some examples, at least some components of the communications manager 815 are implemented at least in part as software stored in a memory. For example, portions of one or more of the components of the communications manager 815 can be implemented as non-transitory code executable by the processor to perform the functions or operations of the respective component.

The receiver 810 may receive one or more reference signals (for example, periodically configured channel state information-reference signals (CSI-RSs), aperiodically configured CSI-RSs, or multi-beam-specific reference signals), synchronization signals (for example, synchronization signal blocks (SSBs)), control information, or data information, such as in the form of packets, from one or more other wireless communication devices via various channels including control channels (for example, a physical uplink control channel (PUCCH) or a physical sidelink control channel (PSCCH)) and data channels (for example, a physical uplink shared channel (PUSCH) or a physical sidelink shared channel (PSSCH)). The other wireless communication devices may include, but are not limited to, a UE 120, described with reference to FIGS. 1, 2, and 3.

The received information may be passed on to other components of the wireless communication device 800. The receiver 810 may be an example of aspects of the receive processor 238 described with reference to FIG. 2. The receiver 810 may include a set of radio frequency (RF) chains that are coupled with or otherwise utilize a set of antennas (for example, the set of antennas may be an example of aspects of the antennas 234 described with reference to FIG. 2).

The transmitter 820 may transmit signals generated by the communications manager 815 or other components of the wireless communication device 800. In some examples, the transmitter 820 may be collocated with the receiver 810 in a transceiver. The transmitter 820 may be an example of aspects of the transmit processor 220 described with reference to FIG. 2. The transmitter 820 may be coupled with or otherwise utilize a set of antennas (for example, the set of antennas may be an example of aspects of the antennas 234), which may be antenna elements shared with the receiver 810. In some examples, the transmitter 820 is configured to transmit control information in a physical downlink control channel (PDCCH) or a PSCCH and data in a physical downlink shared channel (PDSCH) or PSSCH.

The communications manager 815 may be an example of aspects of the controller/processor 240 described with reference to FIG. 2. The communications manager 815 includes the latency report component 830 and the grant component 840. In some examples, working in conjunction with the receiver 810, the latency report component 830 receives, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. Additionally, working in conjunction with the transmitter 820, the grant component 840 adjusts a configuration of a second set of uplink packets in accordance with receiving the latency report. Furthermore, the transmitter 820 may transmit the second set of uplink packets in accordance with the grant component 840 adjusting the configuration.

FIG. 9 is a flow diagram illustrating an example process 900 performed by a network node, in accordance with some aspects of the present disclosure. The example process 900 is an example of a receiving a latency report. As shown in FIG. 9, the process 900 begins at block 902 by receiving, from a second wireless communication device, a latency report indicating a first latency value associated with a first uplink packet of a first set of uplink packets associated with a MAC TB, a second latency value associated with a second uplink packet of the first set of uplink packets, and a number of uplink packets lost in the first set of uplink packets. At block 904, the process 900 adjusts a configuration of a second set of uplink packets in accordance with receiving the latency report. At block 906, the process 900 transmits the second set of uplink packets in accordance with adjusting the configuration.

Implementation examples are described in the following numbered clauses:
Clause 1. A method for wireless communication by a first wireless communication device, comprising: receiving, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets; adjusting a configuration of a second set of uplink packets in accordance with receiving the latency report; and transmitting the second set of uplink packets in accordance with adjusting the configuration.
Clause 2. The method of Clause 1, wherein the first wireless communication device is a network node and the second wireless communication device is a user equipment (UE).
Clause 3. The method of Clause 2, further comprising transmitting a message indicating a latency report configuration, wherein: the latency report is received based on transmitting the message.
Clause 4. The method of Clause 3, wherein: the latency report configuration indicates a periodicity of the latency report; and the latency report configuration is included in a radio resource control (RRC) message or a quality of service (QoS) configuration message.
Clause 5. The method of Clause 4, wherein: the first latency value is a first average latency associated with a group of initial uplink packets over a previous period of time; and the second latency value is a second average latency associated with a group of last uplink packets over the previous period of time.
Clause 6. The method of any one of Clauses 3, wherein the latency report configuration is an on-demand request for the latency report.
Clause 7. The method of any one of Clauses 2-6, wherein adjusting the configuration of the second set of uplink packets comprises: adjusting one or more of a grant size of the second set of uplink packets; adjusting a periodicity of the second set of uplink packets; adjusting a timing of the second set of uplink packets; adjusting a grant associated with the second set of uplink packets from a configured grant to a dynamic grant; or adjusting a logical channel configuration.
Clause 8. The method of any one of Clauses 2-6, further comprising transmitting, to a session management function (SMF), a message requesting an update to QoS characteristics in accordance with receiving the latency report.
Clause 9. The method of any one of Clauses 2-8, further comprising, in accordance with receiving the latency report: adjusting a QoS codec, dynamically enabling and/or disabling one or more component carriers, adjusting a radio bearer mapping, adapting radio access network (RAN) resources, enabling or disabling packet data convergence protocol (PDCP) duplication, adjusting a carrier group mapping, moving a quality of service (QoS) flow to a different slice, updating a UE route selection policy (URSP), and/or updating the URSP for one slice of a group of slices.
Clause 10. The method of any one of Clauses 1-9, wherein the latency report is received in a packet data convergence protocol (PDCP) control protocol data unit (PDU), a radio link control (RLC) PDU, a radio resource configuration (RRC) message, a service data adaptation protocol (SDAP) control PDU, or a medium access control (MAC) control element (CE) (MAC-CE).
Clause 11. The method of any one of Clauses 1-10, wherein the latency report is associated with: the QoS flow or a group of QoS flows at a bearer level, a specific radio bearer, a specific logical channel, and/or a protocol data unit (PDU) set type.
Clause 12. The method of any one of Clauses 1-11, wherein the latency report includes a QoS flow identifier (QFI).
Clause 13. The method of any one of Clauses 1-12, wherein the latency report includes one or more bits indicated parameters associated with the first set of packets.
Clause 14. The method of any one of Clauses 1 or 10-13, wherein the first wireless communication device is a user equipment (UE) and the second communication wireless device is a network node.
Clause 15. The method of Clause 14, wherein adjusting the configuration of the second set of uplink packets comprises adjusting a timing of the second set of uplink packets.
Clause 16. The method of any one of Clauses 1-15, wherein the first set of packets and the second set of packets are protocol data unit (PDU) packets or belong to specific PDU sets.
Clause 17. The method of any one of Clauses 1-16, wherein: the first uplink packet is an initial packet in the MAC TB and the second uplink packet is a final packet in the MAC TB or a quality of service (QoS) flow of a plurality of QoS flows associated with the MAC TB.
Clause 18. An apparatus comprising at least one processor, at least one memory coupled with the at least one processor, and instructions stored in the at least one memory and operable, when executed by the at least one processor to cause the apparatus to perform any one of Clauses 1 through 17.
Clause 19. An apparatus comprising at least one means for performing any one of Clauses 1 through 17.
Clause 20. A computer program comprising code for causing an apparatus to perform any one of Clauses 1 through 17.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication by a first wireless communication device, comprising:
receiving, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets;
adjusting a configuration of a second set of uplink packets in accordance with receiving the latency report; and
transmitting the second set of uplink packets in accordance with adjusting the configuration.

2. The method of claim 1, wherein the first wireless communication device is a network node and the second wireless communication device is a user equipment (UE).

3. The method of claim 2, further comprising transmitting a message indicating a latency report configuration, wherein: the latency report is received based on transmitting the message.

4. The method of claim 3, wherein:
the latency report configuration indicates a periodicity of the latency report; and
the latency report configuration is included in a radio resource control (RRC) message or a quality of service (QoS) configuration message.

5. The method of claim 4, wherein:
the first latency value is a first average latency associated with a group of initial uplink packets over a previous period of time; and
the second latency value is a second average latency associated with a group of last uplink packets over the previous period of time.

6. The method of claim 3, wherein the latency report configuration is an on-demand request for the latency report.

7. The method of claim 2, wherein adjusting the configuration of the second set of uplink packets comprises:
adjusting one or more of a grant size of the second set of uplink packets;
adjusting a periodicity of the second set of uplink packets;
adjusting a timing of the second set of uplink packets; adjusting a grant associated with the second set of uplink packets from a configured grant to a dynamic grant; or adjusting a logical channel configuration.

8. The method of claim 2, further comprising transmitting, to a session management function (SMF), a message requesting an update to QoS characteristics in accordance with receiving the latency report.

9. The method of claim 2, further comprising, in accordance with receiving the latency report: adjusting a QoS codec, dynamically enabling and/or disabling one or more component carriers, adjusting a radio bearer mapping, adapting radio access network (RAN) resources, enabling or disabling packet data convergence protocol (PDCP) duplication, adjusting a carrier group mapping, moving a quality of service (QoS) flow to a different slice, updating a UE route selection policy (URSP), and/or updating the URSP for one slice of a group of slices.

10. The method of claim 1, wherein the latency report is received in a packet data convergence protocol (PDCP) control protocol data unit (PDU), a radio link control (RLC) PDU, a radio resource configuration (RRC) message, a service data adaptation protocol (SDAP) control PDU, or a medium access control (MAC) control element (CE) (MAC-CE).

11. The method of claim 1, wherein the latency report is associated with: the QoS flow or a group of QoS flows at a bearer level, a specific radio bearer, a specific logical channel, and/or a protocol data unit (PDU) set type.

12. The method of claim 1, wherein the latency report includes a QoS flow identifier (QFI).

13. The method of claim 1, wherein the latency report includes one or more bits indicated parameters associated with the first set of packets.

14. The method of claim 1, wherein the first wireless communication device is a user equipment (UE) and the second communication wireless device is a network node.

15. The method of claim 14, wherein adjusting the configuration of the second set of uplink packets comprises adjusting a timing of the second set of uplink packets.

16. The method of claim 1, wherein the first set of packets and the second set of packets are protocol data unit (PDU) packets or belong to specific PDU sets.

17. The method of claim 1, wherein: the first uplink packet is an initial packet in the MAC TB and the second uplink packet is a final packet in the MAC TB or a quality of service (QoS) flow of a plurality of QoS flows associated with the MAC TB.

18. An apparatus for wireless communication by a first wireless communication device, comprising:
at least one processor; and
at least one memory coupled with the at least one processor and storing instructions operable, when executed by the at least one processor, to cause the apparatus to:
receive, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets;
adjust a configuration of a second set of uplink packets in accordance with receiving the latency report; and
transmit the second set of uplink packets in accordance with adjusting the configuration.

19. The apparatus of claim 18, wherein the first wireless communication device is a network node and the second wireless communication device is a user equipment (UE).

20. The apparatus of claim 19, wherein:
execution of the instructions further cause the apparatus to transmit a message indicating a latency report configuration;
the latency report is received based on transmitting the message;
the latency report configuration indicates a periodicity of the latency report; and
the latency report configuration is included in a radio resource control (RRC) message or a quality of service (QoS) configuration message.

21. The apparatus of claim 19, wherein execution of the instructions that cause the apparatus to adjust the configuration of the second set of uplink packets further cause the apparatus to:
adjust one or more of a grant size of the second set of uplink packets;
adjust a periodicity of the second set of uplink packets;
adjust a timing of the second set of uplink packets; adjust a grant associated with the second set of uplink packets from a configured grant to a dynamic grant; or
adjust a logical channel configuration.

22. The apparatus of claim 19, wherein execution of the instructions further cause the apparatus to transmit, to a session management function (SMF), a message requesting an update to QoS characteristics in accordance with receiving the latency report.

23. The apparatus of claim 19, wherein execution of the instructions further cause the apparatus to, in accordance with receiving the latency report: adjust a QoS codec, dynamically enable and/or disable one or more component carriers, adjust a radio bearer mapping, adapt radio access network (RAN) resources, enable or disable packet data convergence protocol (PDCP) duplication, adjust a carrier group mapping, move a quality of service (QoS) flow to a different slice, update a UE route selection policy (URSP), and/or update the URSP for one slice of a group of slices.

24. The apparatus of claim 18, wherein the latency report is received in a packet data convergence protocol (PDCP) control protocol data unit (PDU), a radio link control (RLC) PDU, a radio resource configuration (RRC) message, a service data adaptation protocol (SDAP) control PDU, or a medium access control (MAC) control element (CE) (MAC-CE).

25. The apparatus of claim 18, wherein the latency report is associated with: the QoS flow or a group of QoS flows at a bearer level, a specific radio bearer, a specific logical channel, and/or a protocol data unit (PDU) set type.

26. The apparatus of claim 18, wherein the latency report includes one or more bits indicated parameters associated with the first set of packets.

27. The apparatus of claim 18, wherein the first wireless communication device is a user equipment (UE) and the second communication wireless device is a network node.

28. The apparatus of claim 27, wherein execution of the instructions that cause the apparatus to adjust the configuration of the second set of uplink packets further cause the apparatus to adjust a timing of the second set of uplink packets.

29. A non-transitory computer-readable medium having program code recorded thereon for wireless communications at a user equipment (UE), the program code executed by at least one processor and comprising:
program code to receive, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets;
program code to adjust a configuration of a second set of uplink packets in accordance with receiving the latency report; and
program code to transmit the second set of uplink packets in accordance with adjusting the configuration.

30. An apparatus for wireless communication by a first wireless communication device, comprising:
means for receiving, from a second wireless communication device, a latency report indicating a first latency value associated with a first uplink packet of a first set of uplink packets associated with a medium access control (MAC) transport block (TB), a second latency value associated with a second uplink packet of the first set of uplink packets, and a number of uplink packets lost in the first set of uplink packets;
means for adjusting a configuration of a second set of uplink packets in accordance with receiving the latency report; and
means for transmitting the second set of uplink packets in accordance with adjusting the configuration.
